(19) United States
(12) Patent Application Publication
(10) Pub. No.: US 2026/0213329 A1
(43) Pub. Date: Jul. 23, 2026

(54) BATTERY PACK STRUCTURE

(71) Applicant: TOYOTA JIDOSHA KABUSHIKI KAISHA, Toyota-shi (JP)

(72) Inventor: Yuta HIROSE, Miyoshi-shi (JP)

(73) Assignee: TOYOTA JIDOSHA KABUSHIKI KAISHA, Toyota-shi (JP)

(21) Appl. No.: 19/339,733

(22) Filed: Sep. 25, 2025

(30) Foreign Application Priority Data
Jan. 21, 2025 (JP) 2025-008511

(51) Int. Cl. H01M 50/278; B60K 1/04; H01M 50/204; H01M 50/249

(52) U.S. Cl. CPC H01M 50/278; B60K 1/04; H01M 50/249; B60K 2001/0416; B60K 2001/0427; H01M 50/204; H01M 2220/20

(57) ABSTRACT

A battery pack structure includes a battery module and a case that houses the battery module. The case includes a lower case that is disposed below the battery module. The case also includes an upper case that is disposed above the lower case and is made of a fiber reinforced resin.

### CROSS-REFERENCE TO RELATED APPLICATION

This application claims priority to Japanese Patent Application No. 2025-008511 filed on Jan. 21, 2025. The disclosure of the above-identified application, including the specification, drawings, and claims, is incorporated by reference herein in its entirety.

### BACKGROUND

### 1. Technical Field

The present disclosure relates to a battery pack structure.

### 2. Description of Related Art

Japanese Unexamined Patent Application Publication No. 2021-070386 (JP 2021-070386 A) discloses a vehicle battery case structure that houses a battery to be mounted on a vehicle. In the vehicle battery case structure described in this document, a housing portion for a battery module is formed by a first side member and a second side member that are disposed to face each other. One or both of the first side member and the second side member have a skeletal hollow portion located on the side of the battery module and an under hollow portion located below the battery module, and also have a clearance hollow portion formed between the housing bottom of the housing portion of the battery module and the under hollow portion. By integrally forming the skeletal hollow portion, the clearance hollow portion, and the under hollow portion, it is possible to achieve both the effect of protecting the battery mounted on the vehicle and the space saving.

### SUMMARY

In a battery pack including a battery module and a case that houses the battery module, it is desirable to suppress the formation of an unnecessary space between the battery module and the case. The configuration described in JP 2021-070386 A has room for improvement in this regard.

In view of the above fact, an object of the present disclosure is to provide a battery pack structure that can suppress the formation of an unnecessary space between a battery module and a case.

A battery pack structure according to a first aspect includes: a battery module; a lower case disposed below the battery module and constituting a part of a case that houses the battery module; and an upper case disposed above the lower case, made of a fiber reinforced resin, and constituting another part of the case.

In the battery pack structure according to the first aspect, the battery module is housed in the case. The case includes the lower case and the upper case disposed above the lower case. The upper case is made of the fiber reinforced resin. In this configuration, the upper case is less subject to restrictions in terms of the shape of the upper case compared to, for example, a configuration in which the upper case is made of a metal plate. Therefore, it is possible to suppress the formation of an unnecessary space between the battery module and the case (upper case).

In a battery pack structure according to a second aspect, in the battery pack structure according to the first aspect, the upper case includes side walls covering the battery module on sides of the battery module, and an inclination angle of the side walls with respect to an up-down direction is set to 0.5° or less.

In the battery pack structure according to the second aspect, the inclination angle of the side walls of the upper case with respect to the up-down direction can be set to 0.5° or less because the upper case is made of the fiber reinforced resin. Therefore, it is possible to suppress the formation of an unnecessary space between the battery module and the side walls of the upper case.

The battery pack structure according to the present disclosure has the excellent effect of suppressing the formation of an unnecessary space between the battery module and the case.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a side view schematically showing a vehicle to which a battery pack structure of an embodiment is applied;

FIG. 2 is a plan view schematically showing a lower portion of the vehicle to which the battery pack structure of the embodiment is applied;

FIG. 3 is a perspective view of a battery pack etc. as viewed obliquely from the left front side;

FIG. 4 is a sectional view showing a cross section of a battery pack case taken along line 4-4 shown in FIG. 3;

FIG. 5 is a sectional view showing a cross section of the battery pack case taken along line 5-5 shown in FIG. 3; and

FIG. 6 is a schematic diagram illustrating a manufacturing process for an upper case.

### DETAILED DESCRIPTION OF EMBODIMENTS

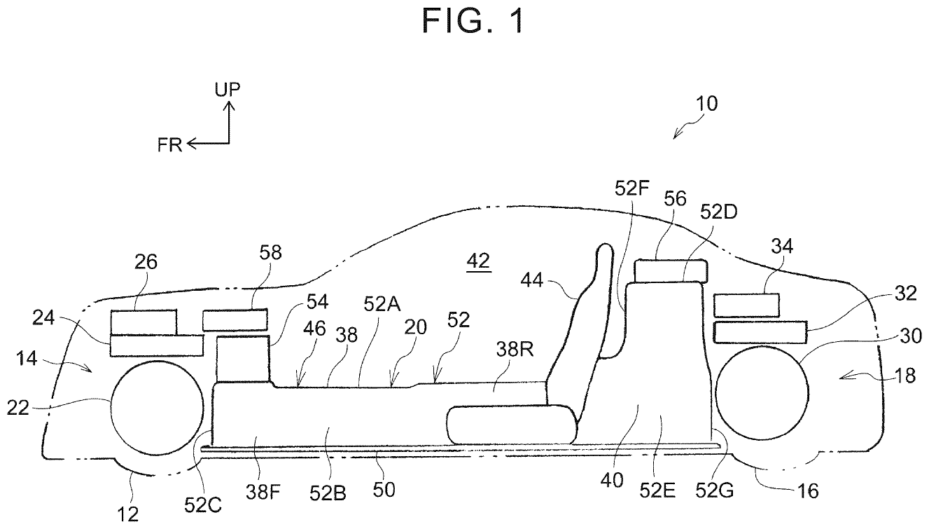

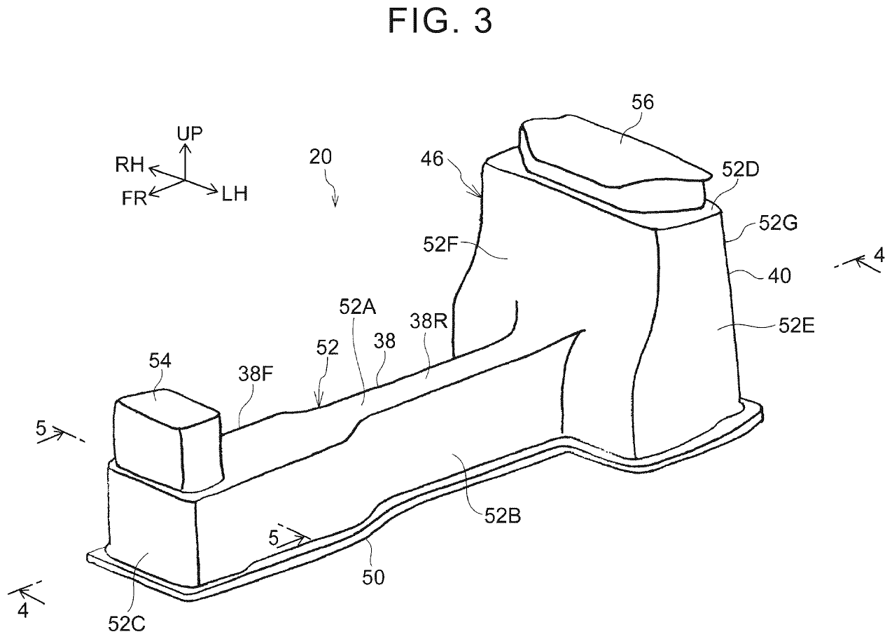

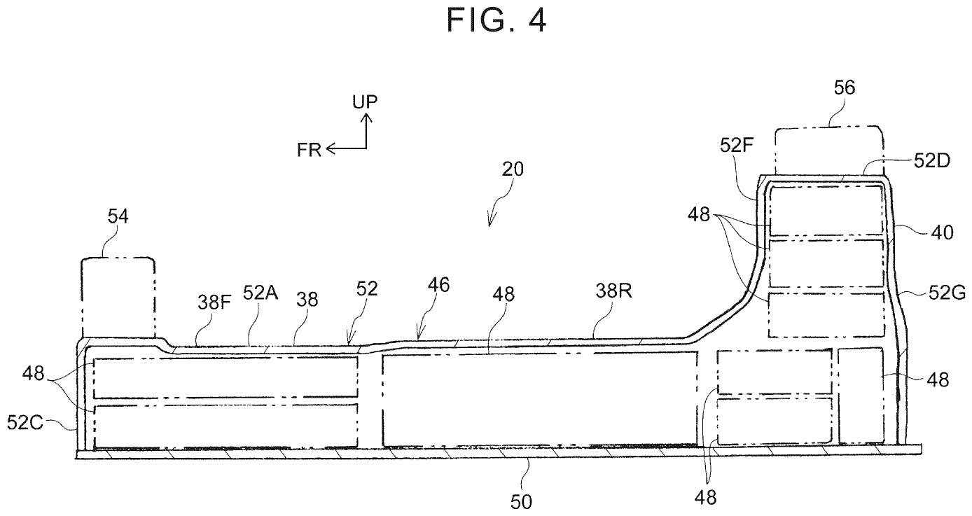

A vehicle 10 to which a battery pack structure according to an embodiment of the present disclosure is applied will be described with reference to FIGS. 1 to 6. Of the arrows shown as appropriate in the drawings, arrow FR indicates a vehicle front side, arrow UP indicates a vehicle upper side, arrow LH indicates a left side in a vehicle width direction (right-left direction), and arrow RH indicates a right side in the vehicle width direction (right-left direction). Terms regarding directions of front-rear, up-down, and right-left when used in the following description indicate front-rear in a vehicle front-rear direction, up-down in a vehicle up-down direction, and right-left in the vehicle right-left direction, unless specified otherwise.

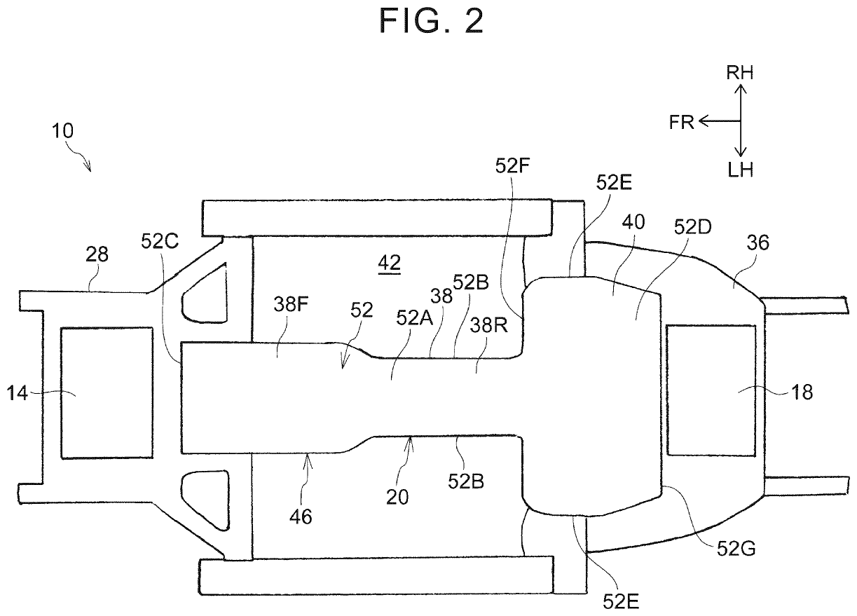

As shown in FIGS. 1 and 2, the vehicle 10 of the present embodiment includes a front E-axle 14 that drives front wheels 12, a rear E-axle 18 that drives rear wheels 16, and a battery pack 20 that stores electric power to be supplied to the front E-axle 14 and the rear E-axle 18.

The front E-axle 14 includes a motor 22, an inverter 24, various devices 26, etc. The front E-axle 14 is supported by a front member 28 provided at the front of the vehicle 10.

Similarly to the front E-axle 14, the rear E-axle 18 includes a motor 30, an inverter 32, various devices 34, etc. The rear E-axle 18 is supported by a rear member 36 provided at the rear of the vehicle 10.

As shown in FIGS. 1, 2, and 3, the battery pack 20 is disposed at the center of the vehicle 10 in the vehicle width direction. The battery pack 20 includes a first battery pack portion 38 having a rectangular parallelepiped shape with its longitudinal direction being the front-rear direction and constituting a portion from the front to the center of the battery pack 20 in the front-rear direction. The battery pack 20 includes a second battery pack portion 40 having a rectangular parallelepiped shape with its longitudinal direction being the right-left direction and constituting a rear portion of the battery pack 20.

The front end of the first battery pack portion 38 is disposed to adjoin the front E-axle 14 in the front-rear direction. Most of the first battery pack portion 38 is disposed at the center of a cabin 42 in the vehicle width direction. In the present embodiment, vehicle seats 44 are provided on both sides of a rear portion 38R of the first battery pack portion 38 in the right-left direction. The dimension of the rear portion 38R of the first battery pack portion 38 in the vehicle width direction is set smaller than the dimension of a front portion 38F of the first battery pack portion 38 in the vehicle width direction.

The rear end of the second battery pack portion 40 is disposed to adjoin the rear E-axle 18 in the front-rear direction. The dimension of the second battery pack portion 40 in the vehicle width direction is set larger than the dimension of the first battery pack portion 38 in the vehicle width direction. The dimension of the second battery pack portion 40 in the up-down direction is set larger than the dimension of the first battery pack portion 38 in the up-down direction.

As shown in FIGS. 2, 3, 4, and 5, the battery pack 20 includes a case 46 constituting the outer shell of the battery pack 20, and a plurality of battery modules 48 housed inside the case 46.

The case 46 includes a lower case 50 extending in the front-rear direction and the right-left direction along the lower portion of the vehicle 10, and an upper case 52 attached to the lower case 50 from above. A space where the battery modules 48 are disposed is formed between the lower case 50 and the upper case 52. The battery module 48 is, for example, structured such that a plurality of battery cells is stacked. The space between the lower case 50 and the upper case 52 includes a portion where the battery modules 48 are supported by the lower case 50 while being stacked in the up-down direction.

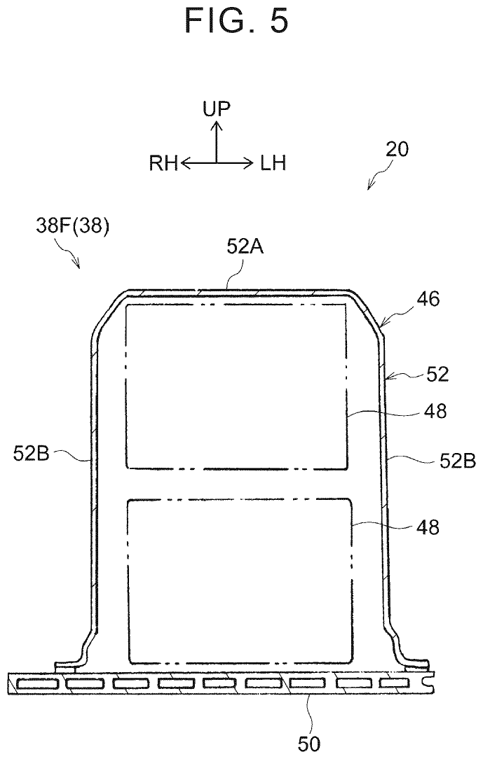

The lower case 50 is made of an extruded material such as an aluminum alloy. The lower case 50 is joined to the front member 28 and the rear member 36 by bolts etc. to function as a member for ensuring the rigidity of the lower portion of the vehicle 10. In the present embodiment, the lower case 50 has a hollow structure (see FIG. 5).

The upper case 52 is made of a fiber reinforced resin such as a CFRP or a GFRP. A portion of the upper case 52 corresponding to the first battery pack portion 38 includes an upper wall 52A extending in the front-rear direction and the right-left direction with its thickness direction being the up-down direction, and a pair of right and left side walls 52B extending downward from both ends of the upper wall 52A in the right-left direction. The portion of the upper case 52 corresponding to the first battery pack portion 38 includes a front wall 52C extending downward from the front end of the upper wall 52A and including both ends in the right-left direction connected to the right and left side walls 52B.

A portion of the upper case 52 corresponding to the second battery pack portion 40 includes an upper wall 52D extending in the front-rear direction and the right-left direction with its thickness direction being the up-down direction, and a pair of right and left side walls 52E extending downward from both ends of the upper wall 52D in the right-left direction. The portion of the upper case 52 corresponding to the second battery pack portion 40 includes a front wall 52F extending downward from the front end of the upper wall 52D and including both ends in the right-left direction connected to the right and left side walls 52E. The front wall 52F is connected to the rear end of the upper wall 52A and the rear ends of the right and left side walls 52B that form the portion of the upper case 52 corresponding to the first battery pack portion 38. The portion of the upper case 52 corresponding to the second battery pack portion 40 includes a rear wall 52G extending downward from the rear end of the upper wall 52D and including both ends in the right-left direction connected to the right and left side walls 52E.

A front connector block 54 and a rear connector block 56 to which connectors for various wires are connected are attached to the upper case 52. The front connector block 54 is attached to the front end of the upper wall 52A. The rear connector block 56 is attached to the upper wall 52D. Connectors for wires connected to the inverter 24 and the various devices 26 that constitute the front E-axle 14 and other devices 58 are connected to the front connector block 54. Connectors for wires connected to the inverter 32 and the various devices 34 that constitute the rear E-axle 18 are connected to the rear connector block 56.

As shown in FIGS. 1 to 5, in the present embodiment described above, the upper case 52 constituting a part of the case 46 is made of a fiber reinforced resin. In this configuration, the upper case 52 is less subject to restrictions in terms of the shape of the upper case 52 compared to, for example, a configuration in which the upper case 52 is made of a metal plate. Therefore, it is possible to suppress the formation of an unnecessary space between the battery modules 48 and the case 46 (upper case 52). By suppressing an increase in size of the upper case 52, it is possible to easily dispose other components along the outside of the upper case 52 and to easily route wires and pipes. Since the upper case 52 is made of a fiber reinforced resin, an increase in weight of the battery pack 20 can be suppressed.

In the present embodiment, the battery pack 20 is disposed at a position close to the roll axis of the vehicle 10. Therefore, it is possible to reduce the moment of inertia generated about the roll axis of the vehicle. In the present embodiment, the battery pack 20 is not disposed below the vehicle seats 44. Therefore, the hip point of an occupant sitting on the vehicle seat 44 can be lowered. In the configuration and disposition of the battery pack 20 in the present embodiment, it is possible to realize a low-height and emotional design of the vehicle 10.

In the present embodiment, the lower case 50 can function as a member for ensuring the rigidity of the lower portion of the vehicle 10. The hollow structure of the lower case 50 can contribute to reducing the weight of the vehicle 10. The lower case 50 can also function as a road interference member for the vehicle 10. Therefore, it is possible to omit an additional protection member against road interference. By adjusting the volume of the hollow portion of the lower case 50, it is possible to adjust the amount of energy to be absorbed by deformation of the lower case 50 without changing the dimension of the lower case 50 in the up-down direction.

In the present embodiment, the front connector block 54 and the rear connector block 56 are attached to the front and rear of the battery pack 20, respectively. Therefore, it is possible to increase the degree of freedom in terms of the mounting layout of devices that need to be connected to the battery pack 20. Further, it is possible to suppress an increase in length of the charging path from a charging port to the battery pack 20 (battery modules 48).

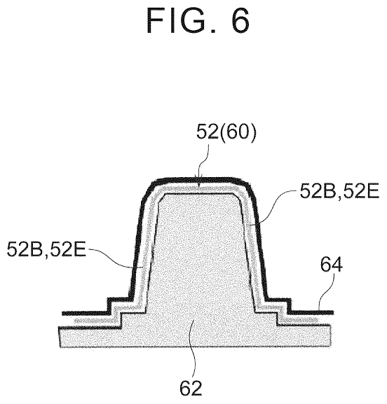

FIG. 6 schematically shows equipment for molding the upper case 52. As shown in this figure, the upper case 52 is molded, for example, in the following procedure. First, prepreg materials 60 that are fiber sheets impregnated with resin are stacked along the surface of a die 62. Next, a bagging film 64 is placed over the prepreg materials 60 stacked along the surface of the die 62. Then, the pressure between the bagging film 64 and the die 62 is reduced. In this way, the upper case 52 is molded. This molding method is called oven molding. The upper case 52 may be molded by autoclave molding in which the pressure between the bagging film 64 and the die 62 is reduced and a pressure is applied around the bagging film 64 and the die 62. When the upper case 52 is molded by oven molding or autoclave molding, for example, the inclination angle of the side walls 52B, 52E of the upper case 52 with respect to the up-down direction can be set to 0.5° or less. Therefore, it is possible to suppress the formation of an unnecessary space between the battery modules 48 and the side walls 52B, 52E of the upper case 52.

While one embodiment of the present disclosure has been described above, the present disclosure is not limited to the above, and can be modified variously without departing from the spirit and scope of the present disclosure.

What is claimed is:

1. A battery pack structure comprising:
a battery module;
a lower case disposed below the battery module and constituting a part of a case that houses the battery module; and
an upper case disposed above the lower case, made of a fiber reinforced resin, and constituting another part of the case.

2. The battery pack structure according to claim 1, wherein:
the upper case includes side walls covering the battery module on sides of the battery module; and
an inclination angle of the side walls with respect to an up-down direction is set to 0.5° or less.
